(19) United States
(12) Patent Application Publication
(10) Pub. No.: US 2021/0110599 A1
(43) Pub. Date: Apr. 15, 2021

(54) DEPTH CAMERA-BASED THREE-DIMENSIONAL RECONSTRUCTION METHOD AND APPARATUS, DEVICE, AND STORAGE MEDIUM

(71) Applicant: Tsinghua University, Beijing (CN)

(72) Inventors: Lu Fang, Shenzhen (CN); Mengqi Ji, Shenzhen (CN); Lei Han, Shenzhen (CN); Zhuo Su, Shenzhen (CN); Qionghai Dai, Shenzhen (CN)

(73) Assignee: Tsinghua University, Beijing (CN)

(21) Appl. No.: 16/977,899

(22) PCT Filed: Apr. 28, 2019
(86) PCT No.: PCT/CN2019/084820

§ 371 Date: Dec. 31, 2020

(30) Foreign Application Priority Data
Mar. 5, 2018 (CN) 201810179264.6

(51) Int. Cl. G06T 17/00; G06F 17/16

(52) U.S. Cl. CPC G06T 17/00; G06T 2200/08; G06F 17/16

(57) ABSTRACT

Provided are a depth camera based three-dimensional reconstruction method and apparatus, a device and a storage medium. The method includes: acquiring at least two frames of images obtained by capturing a target scenario by a depth camera; determining, according to the at least two frames of images, relative camera poses in response to capturing the target scenario by the depth camera; by adopting a manner of at least two levels of nested screening, determining at least one feature voxel from each frame of image, where each level of screening adopts a respective voxel partitioning rule; fusing and calculating the at least one feature voxel of each frame of image according to a respective relative camera pose of each frame of image to obtain a grid voxel model of the target scenario; and generating an isosurface of the grid voxel model to obtain a three-dimensional reconstruction model of the target scenario.

This application claims priority to Chinese Patent Application No. 201810179264.6 filed Mar. 5, 2018 with CNIPA, the disclosure of which is incorporated herein by reference in its entirety.

### TECHNICAL FIELD

Embodiments of the present application relate to the technical field of image processing, for example, to a depth camera based three-dimensional reconstruction method and apparatus, a device and a storage medium.

### BACKGROUND

Three-dimensional reconstruction is to reconstruct a mathematical model of a three-dimensional object in the real world through specific apparatuses and algorithms, and is of great significance to virtual reality, augmented reality, robot perception, human-computer interaction, and robot path planning.

To ensure quality, consistency and real-time performance of a reconstruction result, a high-performance graphics processing unit (GPU) and a depth camera are usually needed in a current three-dimensional reconstruction method to complete the reconstruction. Firstly, a depth camera is used for capturing a target scenario to obtain at least two frames of images; a GPU is used for solving each frame of image to acquire a relative camera pose in response to capturing each frame of image by the depth camera; and according to the relative camera pose corresponding to each frame of image, all voxels in the frame of image are traversed to determine voxels satisfying a certain condition as candidate voxels. Furthermore, according to the candidate voxels in each frame of image, a truncated signed distance function (TSDF) model of the frame of image is constructed. Finally, on the basis of the TSDF model, an isosurface of each frame of image is generated. Thus, real-time reconstruction of the target scenario is completed.

However, the three-dimensional reconstruction method in the related art needs a large amount of computations and is highly dependent on the GPU dedicated to image processing. The GPU is not portable and is difficult to be applied to mobile robots, portable devices and wearable devices (such as an augmented reality head-mounted display device, Microsoft HoloLens).

### SUMMARY

The following is a summary of the subject matter described herein in detail. This summary is not intended to limit the scope of the claims.

Embodiments of the present application provide a depth camera based three-dimensional reconstruction method and apparatus, a device and a storage medium, avoiding a large amount of computations during performing three-dimensional reconstruction on a target scenario, and achieving the application of the three-dimensional reconstruction to portable devices to make the three-dimensional reconstruction more widely applied.

In a first aspect, an embodiment of the present application provides a depth camera based three-dimensional reconstruction method. The method includes the following steps: at least two frames of images obtained by capturing a target scenario by a depth camera are acquired; relative camera poses in response to capturing the target scenario by the depth camera are determined according to the at least two frames of images; for each of the at least two frames of images, by adopting a manner of at least two levels of nested screening, at least one feature voxel is determined from each of the at least two frames of images, where each level of screening adopts a respective voxel partitioning rule corresponding to each level of screening; the at least one feature voxel of each of the at least two frames of images is fused and calculated according to a respective relative camera pose of each of the at least two frames of images to obtain a grid voxel model of the target scenario; and an isosurface of the grid voxel model is generated to obtain a three-dimensional reconstruction model of the target scenario.

In a second aspect, an embodiment of the present application further provides a depth camera based three-dimensional reconstruction apparatus. The apparatus includes: an image acquisition module, a pose determination module, a voxel determination module, a model generation module and a three-dimensional reconstruction module. The image acquisition module is configured to acquire at least two frames of images obtained by capturing a target scenario by a depth camera. The pose determination module is configured to determine, according to the at least two frames of images, relative camera poses in response to capturing the target scenario by the depth camera. The voxel determination module is configured to: for each of the at least two frames of images, by adopting a manner of at least two levels of nested screening, determine at least one feature voxel from each of the at least two frames of images, where each level of screening adopts a respective voxel partitioning rule corresponding to each level of screening.

The model generation module is configured to fuse and calculate the at least one feature voxel of each of the at least two frames of images according to a respective relative camera pose of each of the at least two frames of images to obtain a grid voxel model of the target scenario. The three-dimensional reconstruction module is configured to generate an isosurface of the grid voxel model to obtain a three-dimensional reconstruction model of the target scenario.

In a third aspect, an embodiment of the present application further provides an electronic device. The electronic device includes one or more processors, a memory and at least one depth camera. The memory is configured to store one or more programs, and the at least one depth camera is configured to capture an image of a target scene. The at least one program, when executed by the one or more processors, causes the one or more processors to implement the depth camera based three-dimensional reconstruction method described in any embodiment of the present application.

In a fourth aspect, an embodiment of the present application further provides a computer-readable storage medium storing a computer program, where the computer program, when executed by a processor, implements the depth camera based three-dimensional reconstruction method described in any embodiment of the present application.

Other aspects can be understood after the drawings and the detailed description are read and understood.

### BRIEF DESCRIPTION OF DRAWINGS

To illustrate the technical schemes in exemplary embodiments of the present application more clearly, the drawings used in the embodiments are simply described below. The drawings described below are part, not all, of the drawings of the embodiments described in the present application. Those of ordinary skill in the art may obtain other drawings based on the drawings described below on the premise that no creative work is done.

FIG. 1 is a flowchart of a depth camera based three-dimensional reconstruction method according to an embodiment of the present application;

FIG. 2 is a schematic view of a cube in a manner of two-level nested screening according to an embodiment of the present application;

FIG. 3 is a flowchart of a method for determining relative camera poses in response to capturing a target scenario by a depth camera according to an embodiment of the present application;

FIG. 4 is a flowchart of a method for determining at least one feature voxel from an image according to an embodiment of that present application;

FIG. 5 is a plan view of determining at least one feature voxel according to an embodiment of that present application;

FIG. 6 is a flowchart of a depth camera based three-dimensional reconstruction method according to another embodiment of the present application;

FIG. 7 is a structural block diagram of a depth camera based three-dimensional reconstruction apparatus according to an embodiment of the present application; and

FIG. 8 is a structural diagram of an electronic device according to an embodiment of the present application.

### DETAILED DESCRIPTION

Hereinafter the present application will be described in detail in conjunction with the drawings and embodiments. It is to be understood that the specific embodiments set forth below are intended to explain but not to limit the present application. It is to be additionally noted that for easy of description, only part, not all, of structures related to the present application are illustrated in the drawings.

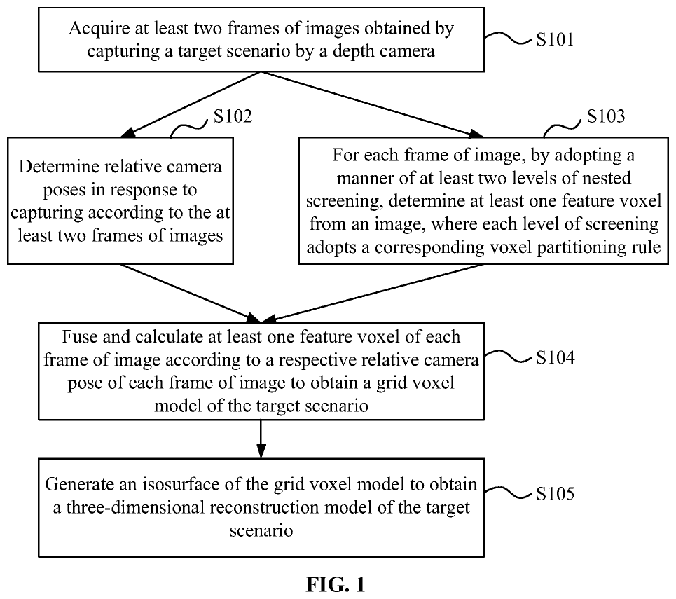

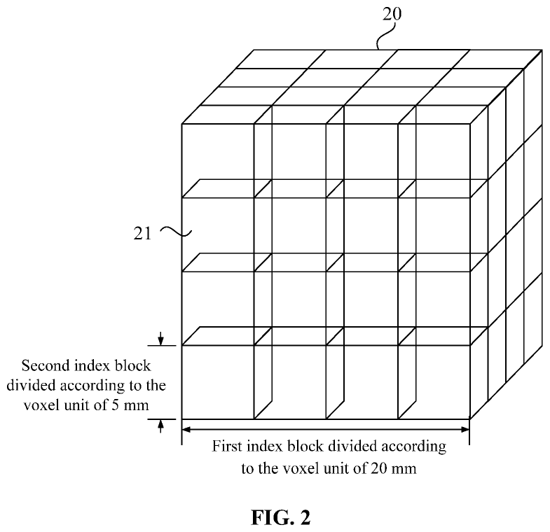

FIG. 1 is a flowchart of a depth camera based three-dimensional reconstruction method according to an embodiment of the present application. This embodiment may be applied to the case where three-dimensional reconstruction is performed on a target scenario based on a depth camera. The method may be executed by a depth camera based three-dimensional reconstruction apparatus or an electronic device. The apparatus may be implemented by hardware and/or software. The depth camera based three-dimensional reconstruction method of FIG. 1 is schematically described below in conjunction with a schematic view of a cube in a manner of two-level nested screening of FIG. 2, and the method includes steps S101 to S105.

In step S101, at least two frames of images obtained by capturing a target scenario by a depth camera are acquired.

The depth camera differs from a traditional camera in that the depth camera can simultaneously capture image information of a scenario and depth information corresponding to the image information. The design principle is as follows: a reference beam is emitted to a to-be-measured target scenario, the time difference or phase difference of the returned light is calculated to be converted into the distance of the captured scenario, thereby generating depth information, and image information is acquired in combination with traditional camera capturing. The target scenario refers to a scenario on which three-dimensional reconstruction is to be performed. For example, when an auto-drive car is driving on a highway, the target scenario is the driving environment scenario of the car, and driving environment images of the car are captured in real time by the depth camera. In an embodiment, to accurately perform three-dimensional reconstruction on the target scenario, at least two frames of images captured by the depth camera need to be acquired for processing, and the more frames are acquired, the more accurate the reconstructed target scenario model is. Images captured by the depth camera may be acquired in many methods, for example, through wired manners such as serial ports and network cables, or through wireless manners such as Bluetooth and wireless broadband.

In step S102, relative camera poses in response to capturing the target scenario by the depth camera are determined according to the at least two frames of images.

The pose of a camera refers to a position and posture of the camera. In an embodiment, the position represents translation distances of the camera (e.g., translation transformations of the camera in X, Y and Z directions), and the posture represents rotation angles of the camera (e.g., angle transformations α, β, and γ of the camera in the X, Y and Z directions).

Since the field angle of the depth camera is fixed and the capturing angle is also fixed, the pose of the camera needs to be changed to accurately perform the three-dimensional reconstruction on the target scenario. The capturing is performed from different positions and angles so that the target scenario may be accurately reconstructed. Therefore, the relative position and relative posture of the depth camera are different when the depth camera captures each frame of image, and may be represented by the relative pose of the depth camera. For example, the depth camera may automatically change the position and posture according to a certain track, or may be manually rotated and moved to perform capturing. Therefore, the relative camera pose when each frame of image is captured needs to be determined to accurately reconstruct the frame of image to the corresponding position of the target scenario.

In an embodiment, the pose of the depth camera may be determined in many methods, for example, the pose of the camera may be directly acquired by mounting a sensor that measures a translation distance and a rotation angle on the depth camera. The relative poses of the depth camera do not change much when the depth camera captures two adjacent frames of images, so to acquire the relative camera pose more accurately, the relative pose of the camera when the camera captures the frame of image may be determined by processing the captured image.

In step S103, for each frame of image, by adopting a manner of at least two levels of nested screening, at least one feature voxel is determined from each frame of image, where each level of screening adopts a respective voxel partitioning rule corresponding to each level of screening.

In the embodiment of the present application, when three-dimensional reconstruction of the target scenario is performed, the reconstructed target scenario is divided into grid-shaped voxel blocks (FIG. 2 shows part of the grid-shaped voxel blocks of the reconstructed target scenario), and each frame of image may also be divided into planar voxel grids by corresponding the grid-shaped voxel blocks to corresponding positions of each frame of image. The image captured by the depth camera includes feature voxels and non-feature voxels when the three-dimensional reconstruction is performed on the target scenario, for example, when the driving environment scenario of a car is to be reconstructed, pedestrians and vehicles in the image are feature voxels, while the blue sky and white clouds in the distance are non-feature voxels. Therefore, voxels in each captured frame of image should be screened to find the feature voxels for the three-dimensional reconstruction of the target scenario. A feature voxel may be comprised of one voxel block or a preset number of voxel blocks.

The computation amount is relatively large if whether a voxel grid in each frame of image is a feature voxel is determined one by one. In an embodiment, at least one feature voxel may be determined from an image by adopting the manner of at least two levels of nested screening and a voxel partitioning rule. In an embodiment, the voxel partitioning rule may include that: at least two levels of voxel units are set; according to a respective level of voxel unit, each level of screening object is divided into at least two index blocks corresponding to the respective level of voxel unit; and the index blocks are screened level by level.

Exemplarily, in combination with FIG. 2, two-level nested screening is taken as an example. It is assumed that two levels of voxel units corresponding to the two-level nested screening are a voxel unit of 20 mm and a voxel unit of 5 mm respectively. An example is described below.

(1) The target scenario grid voxels corresponding to one frame of image are divided into multiple first index blocks according to the voxel unit of 20 mm (cube 20 in FIG. 2 is a first index block divided according to the voxel unit of 20 mm).

(2) A first level of screening is performed on all the divided first index blocks to determine whether a feature voxel is included therein. Based on the determination result that a first index block (cube 20) does not include a feature voxel, the first index block is removed; based on the determination result that a first index block (cube 20) includes a feature voxel, the first index block is selected as a feature block.

(3) It is assumed that the cube 20 in FIG. 2 includes the feature voxel, and the selected feature block (cube 20) is further divided according to the voxel unit of 5 mm. Each feature block (cube 20) may be divided into 4×4×4 second index blocks (cube 21 in FIG. 2 is a second index block divided according to the voxel unit of 5 mm).

(4) A second level of screening is performed on all the divided second index blocks to determine whether a feature voxel is included therein. Based on the determination result that a second index block (cube 21) does not include a feature voxel, the second index block is removed; based on the determination result that a second index block (cube 21) includes a feature voxel, the second index block is selected as a feature voxel.

In the case of multi-level nested screening, except that the entire frame of image is divided into multiple index blocks for the first screening, for each of the remaining several levels of nested screening, a feature block including a feature voxel and screened out from the previous nested screening is used as an object to be divided for the next level of screening, and is divided into multiple index blocks according to the next level of voxel unit, to determine whether a feature voxel is included until the nested screening according to the last level of voxel unit is completed. For example, in the case of three-level nested screening, after the above-mentioned operations of two levels of screening are performed, since the screening according to the third level of voxel unit has not been performed, all the second index blocks (cube 21) including the feature voxel obtained in step (4) of the two-level nested screening as objects to be divided in the third level of screening, and are divided into multiple index blocks according to the third level of voxel unit, and then the determination whether the feature voxel is included is performed.

In step S104, at least one feature voxel of each frame of image is fused and calculated according to a respective relative camera pose of each frame of image to obtain a grid voxel model of the target scenario.

After at least one feature voxel corresponding to the image is determined in step S103, to obtain the grid voxel model of the target scenario, the determined at least one feature voxel needs to be fused and calculated in combination with the relative camera pose in response to capturing the frame of image by the depth camera, to obtain the grid voxel model of the target scenario. Each voxel in the grid voxel model stores a distance to a surface of the target scenario and weight information indicating observation uncertainty.

In an embodiment, the grid voxel model in this embodiment may be a TSDF model. As shown in FIG. 2, it is assumed that the cube 21 is a feature voxel obtained by multi-level nested screening, each feature voxel in each frame of image is fused and calculated according to formula

$${tsdf}^{a v g} = \frac{{tsdf}_{i - 1} {w}_{i - 1} + {tsdf}_{i} {w}_{i}}{{w}_{i - 1} + {w}_{i}} ,$$

thus obtaining a TSDF model of the target scenario, where tsdf^{avg} is a fusion result of current feature voxels, tsdfᵢ₋₁ is a distance from a previous feature voxel to the surface of the target scenario, wᵢ₋₁ is weight information of the previous feature voxel, tsdfᵢ is a distance from a current feature voxel to the surface of the target scenario, and wᵢ is weight information of the current feature voxel.

In an embodiment, during screening the feature voxel in step S103, to increase the screening rate, the feature voxel screened out may include a preset number of voxel blocks corresponding to a voxel unit (for example, a feature voxel may be comprised of 8×8×8 voxel blocks). In this way, when the fusion and calculation is performed, voxel blocks in each feature voxel may be fused and calculated according to a certain number, for example, the 8×8×8 voxel blocks in the feature voxel may be fused and calculated by taking 2×2×2 voxel blocks as a fusion object (i.e., a voxel).

In an embodiment, the feature voxels selected in step S103 may be fused and calculated simultaneously in parallel to increase the fusion rate of the grid voxel model of the target scenario.

In step S105, an isosurface of the grid voxel model is generated to obtain a three-dimensional reconstruction model of the target scenario.

The grid voxel model of the target scenario obtained in step S104 is a distance model from the feature voxel to the surface of the target scenario. To obtain the three-dimensional reconstruction model of the target scenario, the isosurface needs to be generated on the basis of the grid voxel model. For example, a Marching Cubes algorithm may be used for generating the isosurface (i.e., generating a triangular facet representing the surface of the model), trilinear interpolation is used for color extraction and addition, and normal vector extraction, thereby obtaining the three-dimensional reconstruction model of the target scenario.

When the depth camera captures images of the target scenario, most of scenarios in two adjacent frames of images are coincident. To increase the generation rate of the three-dimensional reconstruction model, in an embodiment, the step of generating the isosurface of the grid voxel model may include the following steps: in response to that a current frame of image obtained by capturing the target scenario is determined as a key frame, an isosurface of a voxel block corresponding to the current key frame is generated, and a color is added to the isosurface to obtain the three-dimensional reconstruction model of the target scenario.

The key frame is set after the similarity of feature points between two frames of images captured by the depth camera is determined and processing is performed. For example, one key frame may be set for several consecutive frames of images with high similarity. During generation of the isosurface, only the key frame is processed to generate the isosurface of voxel blocks corresponding to each key frame of image. At this time, the obtained model has no color information and multiple objects in the image are not easy to be identified. For example, the reconstructed target scenario is the driving environment scenario of the car, and in this case, pedestrians, vehicles and roads are a whole in the model in which the isosurface is generated. It is impossible to distinguish which part is pedestrians and which part is vehicles. Therefore, colors need to be added to the generated isosurface according to color information in each frame of image, thus clearly identifying multiple objects in the three-dimensional reconstruction model of the target scenario.

It is to be noted that the three-dimensional reconstruction process is a real-time dynamic process. As the camera captures images, the relative camera pose in response to capturing each frame of image is determined in real time, and for the corresponding image, the feature voxel is determined, and the grid voxel model and the isosurface of the grid voxel model are generated.

This embodiment provides the depth camera based three-dimensional reconstruction method. The images of the target scenario captured by the depth camera are acquired; the relative camera poses in response to capturing the images of the target scenario by the depth camera are determined; the feature voxel of each frame of image is determined by adopting the manner of at least two levels of nested screening; the fusion and calculation is performed to obtain the grid voxel model of the target scenario; and the isosurface of the grid voxel model is generated to obtain the three-dimensional reconstruction model of the target scenario. In the stage of fusion and calculation, the manner of at least two levels of nested screening is adopted to determine the feature voxel of each frame of image without traversing voxels one by one, thus reducing the calculation amount, greatly improving the fusion speed while ensuring the reconstruction accuracy, and further improving the efficiency of three-dimensional reconstruction. A large amount of computation during three-dimensional reconstruction of a target scenario is avoided, and the application of the three-dimensional reconstruction to portable devices is achieved to make the three-dimensional reconstruction more widely applied.

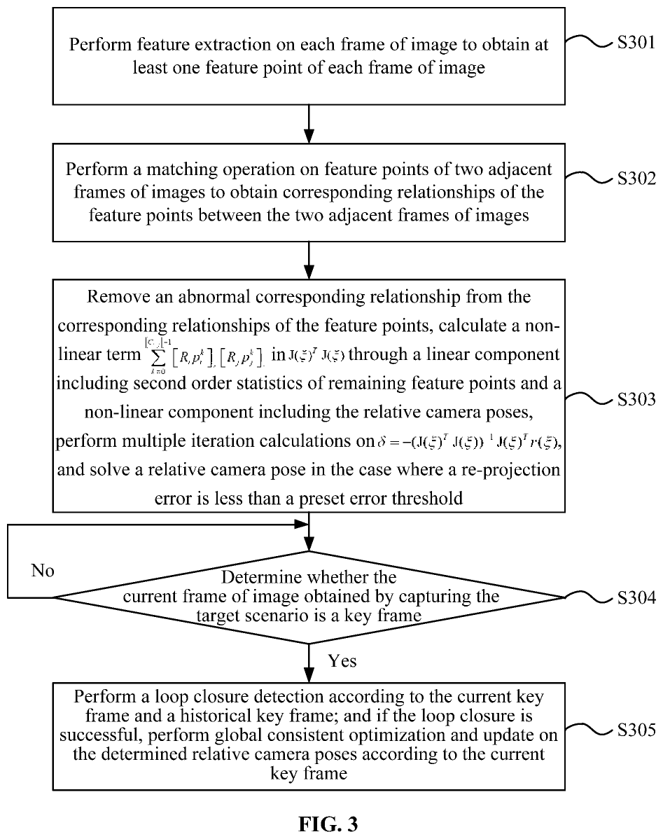

Based on the above embodiment, the step S102 in which the relative camera poses in response to capturing the target scenario by the depth camera are determined according to the at least two frames of images is refined. FIG. 3 is a flowchart of a method for determining relative camera poses in response to capturing a target scenario by a depth camera according to an embodiment of the present application. As shown in FIG. 3, the method includes steps S301 to S305.

In step S301, a feature extraction is performed on each frame of image to obtain at least one feature point of each frame of image.

The feature extraction performed on an image is to find some pixel points (i.e., feature points) having symbolic features in the frame of image. For example, the feature points may be pixel points at corners, pixel points at textures, and pixel points at edges in a frame of image. For feature extraction of each frame of image, an Oriented FAST and Rotated BRIEF (ORB) algorithm may be used for finding at least one feature point in the frame of image.

In step S302, a matching operation is performed on feature points of two adjacent frames of images to obtain corresponding relationships of the feature points between the two adjacent frames of images.

When images of the target scenario are captured, most of the content of the two adjacent frames of images is the same, so corresponding relationships of the feature points between the two frames of images exist. In an embodiment, a fast search manner (sparse matching algorithm) may be used for comparing Hamming distances of feature points between two adjacent frames of images to obtain the corresponding relationships of the feature points between the two adjacent frames of images.

In an embodiment, a pair of feature points between two adjacent frames of images is taken as an example. It is assumed that feature points X1 and X2 representing the same texture feature in the two frames of images are respectively located at different positions in the two frames of images. H (X1, X2) represents the Hamming distance between the two feature points X1 and X2, an XOR operation is performed on the two feature points, and the number of the results which are 1 is counted as the Hamming distance (i.e., a corresponding relationship of the pair of feature points) of the pair of feature points between the two adjacent frames of images.

In step S303, an abnormal corresponding relationship is removed from the corresponding relationships of the feature points, a non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$

in J(ξ)^{T}J(ξ) is calculated through a linear component including second order statistics of remaining feature points and a non-linear component including the relative camera poses, multiple iteration calculations are performed on δ=−(J(ξ)^{T}J(ξ))⁻¹J(ξ)^{T}r(ξ), and a relative camera pose in the case where a re-projection error is less than a preset error threshold is solved. For example, a Gauss-Newton method may be used for the iteration calculations. For example, the pose in the case where the re-projection error is minimized may be calculated.

Here, r(ξ) denotes a vector including all re-projection errors, J(ξ) is a Jacobian matrix of r(ξ), ξ denotes a Lie algebra of a relative camera pose, and δ denotes a delta value of r(ξ) at each iteration; Rᵢ denotes a rotation matrix of a camera when an i-th frame of image is captured; Rⱼ denotes a rotation matrix of the camera when a j-th frame of image is captured; pᵢ^{k} denotes a k-th feature point on the i-th frame of image; pⱼ^{k} denotes a k-th feature point on the j-th frame of image; C_{i,j} denotes a set of corresponding relationships of feature points between the i-th frame of image and the j-th frame of image; ∥C_{i,j}∥−1 denotes the number of corresponding relationships of the feature points between the i-th frame of image and the j-th frame of image; [ ]ₓ denotes a vector product; and ∥C_{i,j}∥ denotes norm of C_{i,j}. In an embodiment, the expression of the non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$

is:

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times } = [ \begin{matrix}- {r}_{i 2}^{T} {Wr}_{j 2} - {r}_{i 1}^{T} {Wr}_{j 1} & {r}_{i 1}^{T} {Wr}_{j 0} & {r}_{i 2}^{T} {Wr}_{j 0} \\ {r}_{i 0}^{T} {Wr}_{j 1} & - {r}_{i 2}^{T} {Wr}_{j 2} - {r}_{i 0}^{T} {Wr}_{j 0} & {r}_{i 2}^{T} {Wr}_{j 1} \\ {r}_{i 0}^{T} {Wr}_{j 2} & {r}_{i 1}^{T} {Wr}_{j 2} & - {r}_{i 0}^{T} {Wr}_{j 0} - {r}_{i 1}^{T} {Wr}_{j 1}\end{matrix} ] . \qquad ( 1 )$$

Here,

$$W = {\sum }_{k = 0}^{‖ {C}_{i , j} ‖ - 1} {p}_{i}^{k} {p}_{j}^{{k}^{T}}$$

denotes a linear component, rᵢₗ^{T} and rⱼₗ denote non-linear components, rᵢₗ^{T} is an l-th row in a rotation matrix Rᵢ, rⱼₗ is the transpose of an l-th row in a rotation matrix Rⱼ, and l=0,1,2 (This embodiment starts counting from 0 based on the programming idea, which means the first row of the matrix, and so on).

In an embodiment, part of the corresponding relationships of feature points between two adjacent frames of images obtained in step S302 are abnormal corresponding relationships. For example, in two adjacent frames of images, there must be feature points in a frame of image that the other frame of image does not have. If the matching operation in step S302 is performed on such feature points, abnormal corresponding relationships will occur. In an embodiment, the abnormal corresponding relationships may be removed by using a Random Sample Consensus (RANSAC) algorithm, and the obtained remaining corresponding relationships of feature points may be expressed as C_{i,j}=C_{i,j}^{k}=(pᵢ^{k}, pⱼ^{k})|k=0,1, . . . , ∥C_{i,j}∥−1, where C_{i,j}^{k} denotes a corresponding relationship of the k-th feature point of the i-th frame of image and the k-th feature point of the j-th frame of image, and j=i−1.

When the relative camera pose is determined, a certain error will necessarily occur. Therefore, to determine the camera pose is to solve the non-linear least squares problem between two frames of images with the following expression as the cost function:

$$E ( {T}_{i} , i = 1 , … , N - 1 ) = {{\sum }^{N - 1}}_{i = 1} {\sum }_{j = 0}^{i - 1} {\sum }_{k = 0}^{‖ {C}_{i , j} ‖ - 1} {‖ {T}_{i} {P}_{i}^{k} - {T}_{j} {P}_{j}^{k} ‖}^{2} . \qquad ( 2 )$$

Here, E denotes a re-projection error of the i-th frame of image compared with the j-th frame of image (referring to the previous frame of image in this embodiment) in Euclidean space; Tᵢ denotes the pose in response to capturing the i-th frame of image by the camera (actually referring to a change of the pose in response to capturing i-th frame of image relative to the previous frame of image according to the above explanation of the pose of the camera), and Tⱼ denotes the pose in response to capturing the j-th frame of image by the camera; N denotes the total number of frames captured by the camera; Pᵢ^{k}=[pᵢ^{k}|1] denotes homogeneous coordinates of the k-th feature point pᵢ^{k} on the i-th frame of image, and Pⱼ^{k}=[pⱼ^{k}|1] denotes homogeneous coordinates of the k-th feature point pᵢ^{k} on the j-th frame of image. It is to be noted that in the case where the value of i and the value of k are the same, pᵢ^{k} and Pᵢ^{k} denote the same point, and the difference is that pᵢ^{k} is local coordinates and Pᵢ^{k} is homogeneous coordinates.

In an embodiment, when the relative camera pose is determined, to increase the computation rate, the above cost function is not directly calculated, but the non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$

in J(ξ)^{T}J(ξ) is calculated through the linear component including the second order statistics of remaining feature points and the non-linear component including the relative camera poses, the multiple iteration calculations are performed on δ=−(J(ξ)^{T}J(ξ))⁻¹J(ξ)^{T}r(ξ), and the relative camera pose in the case where the re-projection error is less than the preset error threshold is solved. From the expression of the non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times } ,$$

it can be seen that when the non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$

is calculated, the fixed linear part

$${\sum }_{k = 0}^{‖ {C}_{i , j} ‖ - 1} {p}_{i}^{k} {p}_{j}^{{k}^{T}}$$

between the two frames of images is regarded as a whole W for calculation, and the calculation does not need to be performed according to the number of corresponding relationships of feature points, thus reducing the complexity of the relative camera pose determination algorithm and enhancing the real-time performance of the relative camera pose calculation.

The following is an explanation of the derivation process of Expression (1), and the principle of reducing the complexity of the algorithm is analyzed in combination with the derivation process.

For the camera pose Tᵢ=[Rᵢ/tᵢ] in response to capturing the i-th frame of image by the camera in Euclidean space, Tᵢ actually refers to a pose transformation matrix when the camera captures the i-th frame of image relative to the j-th frame of image (referring to the previous frame of image in this embodiment), where the pose transformation matrix includes a rotation matrix Rᵢ and a translation matrix tᵢ. The rigid transformation Tᵢ in Euclidean space is denoted by Lie algebra ξᵢ in SE3 space, that is, ξᵢ also denotes the camera pose in response to capturing the i-th frame of image by the camera, and the Lie algebra ξᵢ is mapped into Tᵢ in Euclidean space by T(ξᵢ).

For each corresponding relationship C_{i,j}^{k} of features points, the re-projection error of C_{i,j}^{k} is:

r_{i,j}^{k}(ξ)=T(ξᵢ)Pᵢ^{k}−T(ξⱼ)Pⱼ^{k} (3).

The re-projection error of Euclidean space in Expression (1) may be expressed as E(ξ)=∥r(ξ)∥, where r(ξ) denotes a vector including all re-projection errors, that is,

r(ξ)=[. . . , r_{i,j}^{k}(ξ), . . . ], i∈[0, N−1], j∈[i−1], k∈[0, ∥C_{i,j}∥−1] (4).

Here, T(ξᵢ)Pᵢ^{k} may be expressed as (for simplicity, ξᵢ is omitted below):

$${T}_{i} {P}_{i}^{k} = {R}_{i} {p}_{i}^{k} + {t}_{i} = [ \begin{matrix}{r}_{i 0}^{T} {p}_{i}^{k} + {t}_{i 0} \\ {r}_{i 1}^{T} {p}_{i}^{k} + {t}_{i 1} \\ {r}_{i 2}^{T} {p}_{i}^{k} + {t}_{i 2}\end{matrix} ] . \qquad ( 5 )$$

Here, rᵢₗ^{T} denotes the l-th row in the rotation matrix Rᵢ, tᵢₗ denotes an l-th element in the translation vector tᵢ, and l=0,1,2.

$${J}_{{C}_{i , j}}^{T} {J}_{{C}_{i , j}} = {\sum }_{m ∈ {C}_{i , j}} {J}_{m}^{T} {J}_{m} . \qquad ( 6 )$$

Here, J_{C}_{_{i,j}} denotes a Jacobian matrix of the corresponding relationships of the features points ,, between the i-th frame of image and the j-th frame of image; and m denotes the m-th corresponding relationship of the feature points.

$${J}_{m}^{T} {J}_{m} = [ \begin{matrix}0 & … & 0 & … & 0 & … & 0 \\ ⋮ & & ⋮ & & ⋮ & & ⋮ \\ 0 & … & {J}_{i}^{{k}^{T}} {J}_{i}^{k} & … & - {J}_{i}^{{k}^{T}} {J}_{j}^{k} & … & 0 \\ ⋮ & & ⋮ & & ⋮ & & ⋮ \\ 0 & … & - {J}_{j}^{{k}^{T}} {J}_{i}^{k} & … & {J}_{j}^{{k}^{T}} {J}_{j}^{k} & … & 0 \\ ⋮ & & ⋮ & & ⋮ & & ⋮ \\ 0 & … & 0 & … & 0 & … & 0\end{matrix} ] . \qquad ( 7 )$$

Here, Jᵢ^{k}^{^{T}}Jⱼ^{k} is a 6×6 square matrix, Jᵢ^{k}^{^{T}} denotes the transpose of matrix Jᵢ^{k} , and the expression of Jᵢ^{k}^{^{T}}Jⱼ^{k} is as follows:

$${J}_{i}^{{k}^{T}} {J}_{j}^{k} = [ \begin{matrix}{I}_{3 \times 3} & - [ {T}_{j} {P}_{j}^{k} ] \\ - {[ {T}_{i} {P}_{i}^{k} ]}_{\times }^{T} & {{[ {T}_{i} {P}_{i}^{k} ]}_{\times }^{T} [ {T}_{j} {P}_{j}^{k} ]}_{\times }\end{matrix} ] . \qquad ( 8 )$$

Here, I_{3×3} denotes a 3×3 identity matrix. According to Expression (6) and Expression (7), the four non-zero 6×6 sub-matrices in J_{C}_{_{i,j}}^{T}J_{C}_{_{i,j}} are

$${\sum }_{k = 0}^{‖ {C}_{i , j} ‖ - 1} {J}_{i}^{{k}^{T}} {J}_{i}^{k} , {\sum }_{k = 0}^{‖ {C}_{i , j} ‖ - 1} {J}_{i}^{{k}^{T}} {J}_{j}^{k} , {\sum }_{k = 0}^{‖ {C}_{i , j} ‖ - 1} {J}_{j}^{{k}^{T}} {J}_{i}^{k} ,$$

and

$${\sum }_{k = 0}^{‖ {C}_{i , j} ‖ - 1} {J}_{j}^{{k}^{T}} {J}_{j}^{k} \cdot {\sum }_{k = 0}^{‖ {C}_{i , j} ‖ - 1} {J}_{i}^{{k}^{T}} {J}_{j}^{k}$$

is taken as an example for description below, and the other three non-zero sub-matrices are also calculated similarly and will not be repeated here.

$${\sum }_{k = 0}^{‖ {C}_{i , j} ‖ - 1} {J}_{i}^{{k}^{T}} {J}_{j}^{k} = [ \begin{matrix}‖ {C}_{i , j} ‖ {I}_{3 \times 3} & - {[ {T}_{j} {\sum }_{k = 0}^{‖ {C}_{i , j} ‖ - 1} {P}_{j}^{k} ]}_{\times } \\ - {[ {T}_{i} {\sum }_{k = 0}^{‖ {C}_{i , j} ‖ - 1} {P}_{i}^{k} ]}_{\times }^{T} & {\sum }_{k = 0}^{‖ {C}_{i , j} ‖ - 1} {{[ {T}_{i} {P}_{i}^{k} ]}_{\times }^{T} [ {T}_{j} {P}_{j}^{k} ]}_{\times }\end{matrix} ] . \qquad ( 9 )$$

It can be obtained by combining Expression (5) that:

$${\sum }_{k = 0}^{‖ {C}_{i , j} ‖ - 1} {{[ {T}_{i} {P}_{i}^{k} ]}_{\times }^{T} [ {T}_{j} {P}_{j}^{k} ]}_{\times } = - {\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times } - {{[ {t}_{i} ]}_{\times } [ {R}_{j} {\sum }_{k = 0}^{‖ {C}_{i , j} ‖ - 1} {p}_{j}^{k} ]}_{\times } - {{[ {R}_{i} {\sum }_{k = 0}^{‖ {C}_{i , j} ‖ - 1} {p}_{i}^{k} ]}_{\times } [ {t}_{j} ]}_{\times } - {{[ {t}_{i} ]}_{\times } [ {t}_{j} ]}_{\times } . \qquad ( 10 )$$

Here,

$${\sum }_{k = 0}^{‖ {C}_{i , j} ‖ - 1} {p}_{i}^{k} {p}_{j}^{{k}^{T}}$$

is denoted as W; in combination with Expression (5), non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$

in Expression (10) may be simplified to Expression (1); structural term (Pᵢ^{k}, Pⱼ^{k}) in the non-linear term is linearized as W. J_{C}_{_{i,j}}^{T}J_{C}_{_{i,j}} is non-linear for the structural terms Pᵢ^{k}, Pⱼ^{k}. However, according the above analysis, all non-zero elements in

$${\sum }_{k = 0}^{‖ {C}_{i , j} ‖ - 1} {J}_{i}^{{k}^{T}} {J}_{j}^{k}$$

are linearly related to the second order statistics of structural terms in C_{i,j}, and the second order statistics of structural terms are

$${\sum }_{k = 0}^{‖ {C}_{i , j} ‖ - 1} {p}_{i}^{k} , {\sum }_{k = 0}^{‖ {C}_{i , j} ‖ - 1} {p}_{j}^{k} , and {\sum }_{k = 0}^{‖ {C}_{i , j} ‖ - 1} {p}_{i}^{k} {p}_{j}^{{k}^{T}} .$$

That is, the sparse matrix J_{C}_{_{i,j}}^{T}J_{C}_{_{i,j}} is element-linear with respect to the second order statistics of structural terms in C_{i,j}. It is to be noted that the Jacobian matrix of each corresponding relationship C_{i,j}^{k} is determined by geometric terms ξᵢ, ξⱼ and structural terms pᵢ^{k}, pⱼ^{k}. Jacobian matrices corresponding to all corresponding relationships in the same frame pair C_{i,j} share the same geometric terms but have different structural terms. For one frame pair C_{i,j}, the algorithm for calculating J_{C}_{_{i,j}}^{T}J_{C}_{_{i,j}} in the related art depends on the number of corresponding relationships of feature points in C_{i,j}, while J_{C}_{_{i,j}}^{T}J_{C}_{_{i,j}} can be efficiently calculated with a fixed complexity in this embodiment. Only the second order statistics W of the structural items needs to be calculated, and relevant structural items do not need to participate in the calculation for each corresponding relationship, that is, the four non-zero sub-matrices in J_{C}_{_{i,j}}^{T}J_{C}_{_{i,j}} can be calculated with complexity O(1) instead of complexity O(∥C_{i,j}∥).

Therefore, the sparse matrices J^{T}J and J^{T}r required in the non-linear Gauss-Newton optimization iteration steps in δ=−(J(ξ)^{T}J(ξ))⁻¹J(ξ)^{T}r(ξ) can be efficiently calculated with the complexity O(M) instead of the original calculation complexity O(N_{coor}), where N_{coor} denotes the total number of corresponding relationships of feature points between all frame pairs, and M denotes the number of frame pairs. Generally, (N_{coor}) is about 300 in sparse matching and about 10,000 in dense matching, which is much larger than the number M of frame pairs.

According to the above derivation, in the calculation process of camera poses, W is calculated for each frame pair, and then Expressions (1), (10), (9), (8) and (6) are calculated to obtain J_{C}_{_{i,j}}^{T}J_{C}_{_{i,j}}. Then ξ in the case where r(ξ) is the smallest may be calculated through iteration calculation.

In step S304, it is determined whether the current frame of image obtained by capturing the target scenario is a key frame. Step S305 is performed based on the determination result that the current frame of image is the key frame, and step S304 is re-performed for the next frame of image based on the determination result that the current frame of image is not the key frame.

The step in which it is determined whether the current frame of image obtained by capturing the target scenario is the key frame may include the following steps: a matching operation is performed on the current frame of image obtained by capturing the target scenario and a previous key frame of image to obtain a conversion relationship matrix between the current frame of image and the previous key frame of image; and in response to that the conversion relationship matrix is greater than or equal to a preset conversion threshold, the current frame of image is determined as the current key frame.

In an embodiment, similar to the method for determining corresponding relationships of feature points between two adjacent frames of images in S302, a matching operation may be performed on the current frame of image and the previous key frame to obtain a matrix of corresponding relationships of feature points between two adjacent frames of images, and in the case where the matrix is greater than or equal to the preset conversion threshold, the current image is determined as the current key frame. The conversion relationship matrix between the two frames of images may be a matrix comprised of the corresponding relationships of feature points between the two frames of images.

It is to be noted that a first frame of image obtained by capturing the target scenario may be set as a first key frame, and the preset conversion threshold is set in advance according to the motion condition when the depth camera captures images. For example, if the pose changes greatly when the camera captures two adjacent frames of images, the preset conversion threshold is set to be larger.

In step S305, a loop closure detection is performed according to the current key frame and a historical key frame; and in response to that the loop closure is successful, global consistent optimization and update is performed on the determined relative camera poses according to the current key frame.

Global consistent optimization and update refers to the following: in the reconstruction process, as the camera moves, the reconstruction algorithm continuously expands the three-dimensional reconstruction model of the target scenario, and when the depth camera moves to a place the depth camera once reached or to a place where the angle greatly overlaps a historical view angle, the expanded three-dimensional reconstruction model and the generated model are consistently or jointly optimized and updated to a new model, instead of generating interleaving, aliasing and the like. The loop closure detection is to determine, according to the current observation of the depth camera, whether the camera moves to the place the camera once reached or to the place where the angle greatly overlaps the historical view angle, and thus to optimize and reduce accumulated errors.

To increase the optimization rate, if the loop closure detection of the current key frame and the historical key frame is successful (i.e., the depth camera moves to the place the camera once reached or to the place where the angle greatly overlaps the historical view angle), the global consistent optimization and update is performed on the generated model through the current key frame and the historical key frame to reduce the error of the three-dimensional reconstruction model; and in response to that the loop closure detection is unsuccessful, the next key frame is awaited to be subjected to loop closure detection. In an embodiment, the step in which the loop closure detection is performed on the current key frame and the historical key frame may include the following step: a matching operation is performed on the feature points of the current key frame and the feature points of the historical key frame; if the matching degree is high, it is indicated that the loop closure is successful.

In an embodiment, the global consistent optimization and update performed on the relative camera poses is to solve the minimized conversion error between the current key frame and all the historical key frames having high matching degrees by taking

$$E ( {T}_{1} , {T}_{2} , … , {T}_{N - 1} \text{\textbar} {T}_{i} ∈ SE 3 , i ∈ [ 1 , N - 1 ] ) = {\sum }_{i = 0}^{N - 1} {\sum }_{j = i}^{N} {E}_{i , j}$$

as a cost function according to the corresponding relationships between the current key frame and one or more historical key frames having high matching degrees. E(T₁, T₂, . . . , T_{N-1}|Tᵢ∈SE3, i∈[1, N−1]) denotes the conversion errors of all frame pairs (any historical matching key frame and the current key frame forms one frame pair); N is the number of historical key frames having high matching degrees with the current key frame; E_{i,j} denotes the conversion error between the i-th frame and the j-th frame, and the conversion error is the re-projection error.

In an embodiment, in the process of performing update and optimization on the relative camera poses, the relative pose of a non-key frame and the relative pose of a key frame corresponding to the non-key frame need to be kept unchanged. For the optimization and update algorithm, the Bundle Adjustment (BA) algorithm in the related art or the method in step S303 may be used, and the details will not be repeated here.

According to the method for determining the relative camera poses in response to capturing the target scenario by the depth camera, at least one feature point of each frame of image is extracted, the matching operation is performed on feature points between two adjacent frames of images to obtain corresponding relationships of features points between the two adjacent frames of images, the abnormal corresponding relationship is removed, the relative camera poses are calculated through the linear component including remaining corresponding relationships of feature points and the non-linear component including the relative camera poses, the key frame is determined; if the currently captured image is the key frame and the loop closure detection is successful, the global consistent optimization and update is performed on the determined relative camera poses according to the current key frame and the historical key frame. Global consistency is ensured. Meanwhile, the computation amount of three-dimensional reconstruction is reduced, and the application of the three-dimensional reconstruction to portable devices is achieved to make the three-dimensional reconstruction more widely applied.

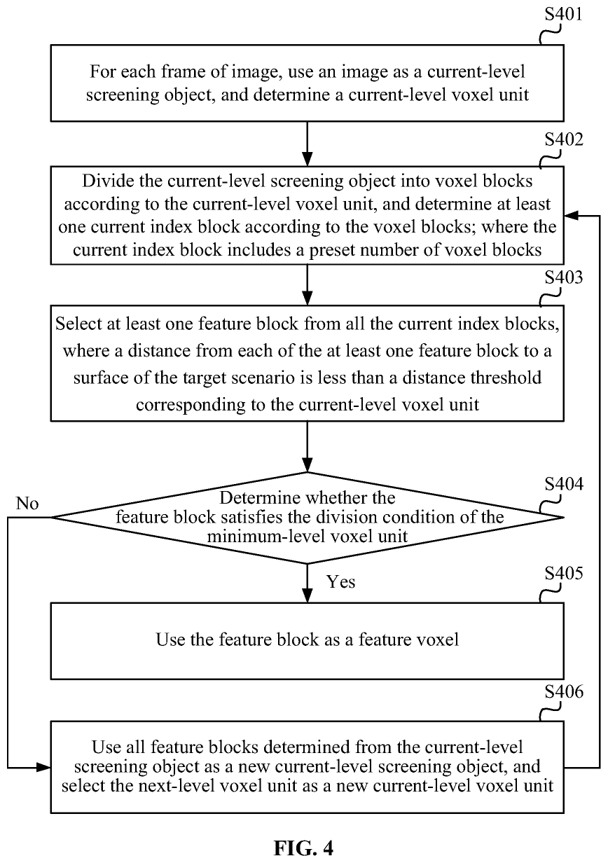

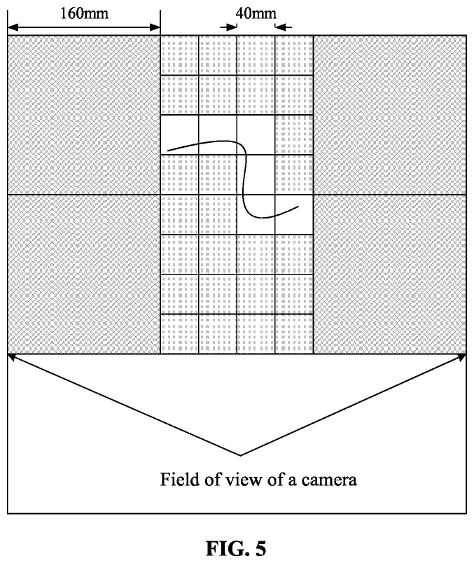

Based on the above embodiment, the step S103 in which for each frame of image, at least one feature voxel is determined from each frame of image by adopting the manner of at least two levels of nested screening is explained. The method for determining at least one feature voxel from an image of FIG. 4 is schematically described below in conjunction with a plan view of determining at least one feature voxel of FIG. 5, and the method includes steps S401 to S406.

In step S401, for each frame of image, the image is used as a current-level screening object, and a current-level voxel unit is determined.

A voxel unit represents the accuracy of the constructed three-dimensional reconstruction model and is set in advance according to the required accuracy of the reconstructed three-dimensional reconstruction model of the target scenario. For example, the voxel unit may be 5 mm, 10 mm, or the like. In this embodiment, at least one feature voxel is determined from each frame of image by adopting the manner of at least two levels of nested screening, therefore, at least two levels of voxel units are set, and the minimum-level voxel unit is the required accuracy of the reconstructed model. Firstly, a captured image is to be used as a current screening object to screen out a feature voxel. At this time, a current voxel unit is the maximum-level voxel unit among the preset multiple levels of voxel units.

Exemplarily, as shown in FIG. 5, it is assumed that real-time three-dimensional reconstruction of a model with a voxel-level accuracy of 5 mm and a frame rate of 100 Hz based on a central processing unit (CPU) is to be implemented, and two-level nested screening of the feature voxel is performed in a voxel unit of 20 mm and a voxel unit of 5 mm, respectively. At this time, the captured image is to be used as the current screening object, and the current-level voxel unit is the voxel unit of 20 mm.

In step S402, the current-level screening object is divided into voxel blocks according to the current-level voxel unit, and at least one current index block is determined according to the voxel blocks; where the current index block includes a preset number of voxel blocks.

To increase the screening rate, when screening is performed on the current-level screening object, at least one index block may be determined according to a preset number and voxel blocks divided according to the current voxel unit, and the screening of the feature voxel may be performed according to the index block. The method increases the screening rate compared with directly performing screening on the voxel blocks divided according to the current voxel unit. It is to be noted that the size of a feature voxel at this time is not the size of one voxel block, but the size of a preset number of voxel blocks.

Exemplarily, as shown in FIG. 5, it is assumed that the current index block is comprised of the preset 8×8×8 voxel blocks. The captured image is divided into multiple voxel blocks having an edge length of 20 mm according to the voxel unit of 20 mm. Then, the divided multiple voxel blocks having the edge length of 20 mm are grouped into at least one index block having an edge length of 160 mm corresponding to the voxel unit of 20 mm according to the number 8×8×8. The entire image is divided into six index blocks having the edge length of 160 mm corresponding to the voxel unit of 20 mm according to an 833 8 box when mapped into a plan view.

In step S403, at least one feature block is selected from all the current index blocks, where a distance from each of the at least one feature block to a surface of the target scenario is less than a distance threshold corresponding to the current-level voxel unit.

The distances from all the current index blocks determined in S402 to the surface of the target scenario are calculated. The smaller the distance, the closer an index block is to the surface of the target scenario. Each level of voxel unit is set with a distance threshold in advance. In the case where the distance from an index block to the surface of the target scenario is less than the distance threshold corresponding to the current-level voxel unit, the index block is selected as a feature block. The distance threshold corresponding to a previous level of voxel unit is greater than the distance threshold corresponding to a next level of voxel unit.

In an embodiment, the step in which at least one feature block is selected from all the current index blocks, where the distance from each of the at least one feature block to the surface of the target scenario is less than the distance threshold corresponding to the current-level voxel unit may include the following steps: for each current index block, the index block is accessed according to a hash value of the current index block, and the distances from all vertices of the current index block to the surface of the target scenario are respectively calculated according to an image depth value obtained by the depth camera and the respective relative camera pose in response to capturing each frame of image; and a current index block, in which the distances from all vertices of the current index block to the surface of the target scenario are each less than the distance threshold corresponding to the current-level voxel unit, is selected as the feature block.

In an embodiment, each current index block may be set with a hash value, and each index block is accessed through the hash value and has multiple vertices. The distance from the voxel block located at each vertex of the current index block to the surface of the target scenario is calculated according to formula sdf=∥ξ−S∥−D(u,v), where sdf denotes the distance from the voxel block (the voxel block at each vertex of the index block) to the surface of the target scenario, ξ denotes the relative camera pose in response to capturing the frame of image, S denotes coordinates of the voxel block in the grid voxel model of the reconstruction space, and D(u, v) denotes a corresponding depth value of the voxel block in the image captured by the depth camera. In the case where the distances from all vertices of the index block to the surface of the target scenario are each less than the distance threshold corresponding to the current-level voxel unit, the index block is set as the feature block; if the distances are greater than or equal to the distance corresponding to the current-level voxel unit, the index block is removed. In an embodiment, an average value of the distances from all vertices of the index block to the surface of the target scenario may also be calculated, and if the average value is less than the distance threshold corresponding to the current voxel unit, the index block is set as the feature block. Exemplarily, as shown in FIG. 5, the squares with diagonal lines having the edge length of 160 mm in the figure are to-be-removed index blocks which are divided according to the voxel unit of 20 mm, that is, the distances from such part of index blocks to the surface of the target scenario are greater than the distance threshold corresponding to the voxel unit of 20 mm.

In step S404, it is determined whether the feature block satisfies a division condition of the minimum-level voxel unit. Step S405 is performed based on the determination result that the feature block satisfies the division condition of the minimum-level voxel unit. Step S406 is performed based on the determination result that the feature block does not satisfy the division condition of the minimum-level voxel unit.

The step of determining whether the feature block satisfies the division condition of the minimum-level voxel unit is to determine whether the feature block selected in step S403 is a feature block selected after division according to the preset minimum-level voxel unit. Exemplarily, as shown in FIG. 5, if the feature block selected in step S403 is a feature block having the edge length of 160 mm divided according to the voxel unit of 20 mm, and the minimum-level voxel unit is the voxel unit of 5 mm, it indicates that the feature block selected in step S403 does not satisfy the division condition of the minimum-level voxel unit of 5 mm, and step S406 is performed to perform the screening according to the next-level voxel unit of 5 mm; if the feature block selected in step S403 is a feature block having an edge length of 40 mm divided according to the voxel unit of 5 mm, it indicates that the feature block selected in step S403 satisfies the division condition of the minimum-level voxel unit of 5 mm, and step S405 is performed to use the feature block as a feature voxel.

In step S405, the feature block is used as the feature voxel.

In step S406, all feature blocks determined from the current-level screening object are used as new current-level screening objects, the next-level voxel unit is selected as a new current-level voxel unit, and the process returns to step S402.

In the case where the feature block selected in step S403 does not satisfy the division condition of the minimum-level voxel unit, all the feature blocks selected in step S403 are used as the new current-level screening object, the next-level voxel unit is selected as a current-level voxel unit, and the process returns to step S402 to perform the screening of the feature block again.

Exemplarily, as shown in FIG. 5, if it is determined that the feature block selected in step S403 is the feature block having the edge length of 160 mm divided according to the voxel unit of 20 mm, but is not the feature block having the edge length of 40 mm divided according to the minimum-level voxel unit of 5 mm, all feature blocks having the edge length of 160 mm divided according to the voxel unit of 20 mm are used as the current-level screening object, the next-level voxel unit of 5 mm is selected as the current-level voxel unit, and the process returns to step S402. All the feature blocks having the edge length of 160 mm screened out in step S403 are divided into multiple voxel blocks having an edge length of 5 mm according to the voxel unit of 5 mm. Then, the divided multiple voxel blocks having the edge length of 5 mm are grouped into at least one index block having the edge length of 40 mm corresponding to the voxel unit of 5 mm according to the number 8×8×8. Mapped to the plan view, the entire image is divided into 32 index blocks having the edge length of 40 mm corresponding to the voxel unit of 5 mm according to 8×8 squares, and then step S403 and step S404 are performed. At this time, the obtained feature blocks having the edge length of 40 mm (such as the blank squares having the edge length of 40 mm in the figure) are the feature blocks selected after division according to the minimum-level voxel unit of 5 mm, i.e., are the selected feature voxels, while the squares with dots having the edge length of 40 mm in FIG. 5 are the to-be-removed index blocks divided according to the voxel unit of 5 mm.

According to the method for determining at least one feature voxel from an image in this embodiment, for each frame of image, at least one feature voxel is determined from each frame of image by adopting the manner of at least two levels of nested screening. A large amount of computation during three-dimensional reconstruction of the target scenario is avoided, and the application of the three-dimensional reconstruction to portable devices is achieved to make the three-dimensional reconstruction more widely applied.

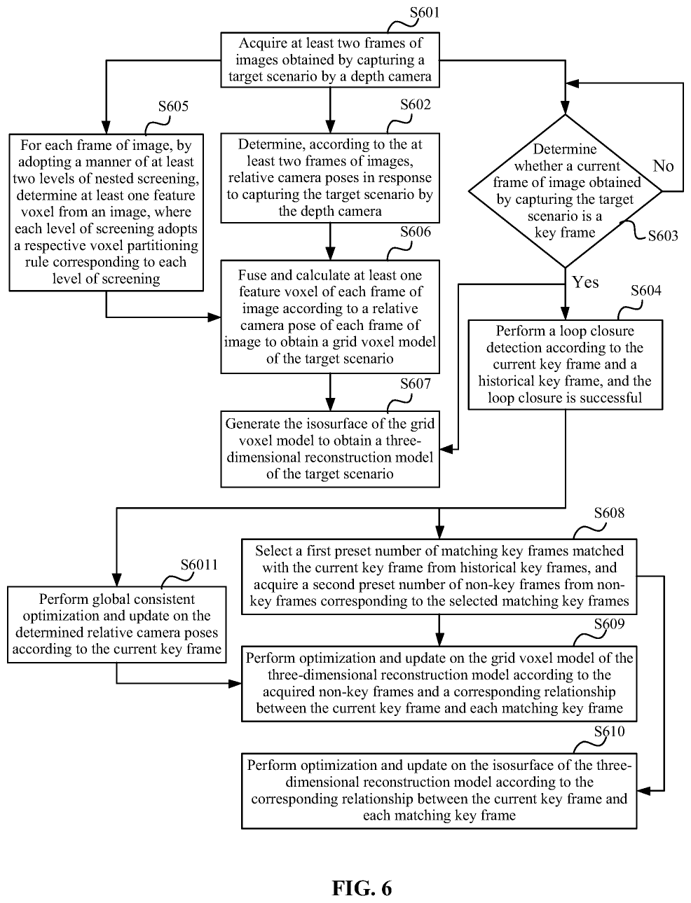

Based on the above embodiments, an exemplary embodiment describing depth camera based three-dimensional reconstruction is provided. As shown in FIG. 6, the method includes steps S601 to S6011.

In step S601, at least two frames of images obtained by capturing a target scenario by a depth camera are acquired.

In step S602, relative camera poses in response to capturing the target scenario by the depth camera are determined according to the at least two frames of images.

In step S603, it is determined whether a current frame of image obtained by capturing the target scenario is a key frame; the key frame is stored and step S604 is performed based on the determination result that the current frame of image is a key frame; step S603 is re-performed for the next frame of image based on the determination result that the current frame of image is not a key frame.

It may be determined whether each frame of image captured by the camera is a key frame, and the determined key frame may be stored to generate an isosurface according to the key frame rate and to be used as a historical key frame in subsequent loop closure optimization. It is to be noted that the first frame captured by the camera is taken as a key frame by default.

In step S604, a loop closure detection is performed according to the current key frame and a historical key frame, and in response to that the loop closure is successful, step S608 is performed (for performing optimization and update of a grid voxel model and an isosurface) and step S6011 is performed (for performing optimization and update of the relative camera poses).

In step S605, for each frame of image, by adopting a manner of at least two levels of nested screening, at least one feature voxel is determined from each frame of image, where each level of screening adopts a respective voxel partitioning rule corresponding to each level of screening.

In step S606, at least one feature voxel of each frame of image is fused and calculated according to a respective relative camera pose of each frame of image to obtain a grid voxel model of the target scenario.

In step S607, the isosurface of the grid voxel model is generated to obtain a three-dimensional reconstruction model of the target scenario.

In step S608, a first preset number of matching key frames matched with the current key frame are selected from historical key frames, and a second preset number of non-key frames are acquired from non-key frames corresponding to the selected matching key frames.

To achieve the global consistency of model reconstruction, in the case where the captured current frame of image is the key frame, the first preset number of matching key frames matched with the current key frame needs to be selected from the historical key frames. In an embodiment, a matching operation may be performed on the current key frame and the historical key frames, for example, the Hamming distances of feature points between the current key frame and the historical key frames may be calculated to complete the matching of the current key frame with the historical key frames. The first preset number of historical key frames having high matching degrees with the current key frame are selected, for example, ten historical key frames having high matching degrees with the current key frame are selected. Each key frame has non-key frames corresponding to it. For each selected historical key frame having a high matching degree, the second preset number of non-key frames also needs to be selected from the non-key frames corresponding to the selected historical key frame having the high matching degree. In an embodiment, no more than eleven non-key frames may be selected evenly and dispersed from all non-key frames corresponding to the historical key frame, so as to improve the efficiency of optimization and update and make the selection of an optimization frame more representative. The first preset number and the second preset number may be set in advance according to needs when the three-dimensional reconstruction model is updated.

In step S609, the optimization and update is performed on the grid voxel model of the three-dimensional reconstruction model according to the acquired non-key frames and a corresponding relationship between the current key frame and each matching key frame.

The optimization and update performed on the grid voxel model of the three-dimensional reconstruction model includes update of the feature voxel and update of the grid voxel model of the target scenario.

In an embodiment, during update of the feature voxels, it is considered that the view angles greatly overlap when the depth camera captures two adjacent frames of images, as a result, the selected feature voxels of two adjacent frames of images are almost consistent, and it takes a long time to performed optimization and update on the feature voxels once for each frame of image. Therefore, step S605 is re-performed only for the matched historical key frame when the features voxels are updated, to complete the optimization and update of the feature voxels.

The grid voxel model of the target scenario generated in step S606 is generated after each frame of image is processed. Therefore, when the grid voxel model of the target scenario is updated, historical key frames having high matching degrees and non-key frames corresponding thereto need all be optimized and updated. That is, when each key frame arrives, for the first preset number of historical key frames having high matching degrees with the current key frame and the second preset number of non-key frames corresponding to each historical frame selected in step S608, the corresponding fusion data is removed, step S606 is re-performed for fusion and calculation, and thus the optimization and update of the grid voxel model of the target scenario is completed.

Regardless of fusion and calculation performed when a grid voxel model of the target scenario is initially obtained or fusion and calculation performed in a stage of optimization and update of the grid voxel model, one voxel block may be used as one fusion object for the fusion and calculation. To improve the fusion efficiency, a preset number of voxel blocks may also be taken as one fusion object for fusion and calculation, such as a voxel with a size of 2×2×2 voxel blocks.

In step S610, the optimization and update is performed on the isosurface of the three-dimensional reconstruction model according to the corresponding relationship between the current key frame and each matching key frame.

The isosurface of the grid voxel model is only generated for the key frame in step S607. Therefore, when the isosurface is updated, step S607 may be only re-performed for the historical key frame selected in step S608 that has a high matching degree with the current key frame to update the isosurface of the matching key frame.

To speed up update and optimization of the model, the step in which the optimization and update is performed on the isosurface of the three-dimensional reconstruction model may include the following steps: for each matching key frame, at least one voxel block is selected from multiple voxel blocks corresponding to the current key frame, where a distance from each of the at least one voxel block to a surface of the target scenario is less than or equal to an update threshold of a corresponding voxel in the matching key frame; and thee optimization and update is performed on an isosurface of each matching key frame according to the selected at least one voxel block.

As for the update threshold, when the isosurface of the grid voxel model is generated in step S607, for each voxel in the key frame used for generating the isosurface, the maximum value may be selected from distances each of which is from one of voxel blocks in the voxel to the surface of the target scenario, and the maximum value is set as the update threshold of the voxel. In other words, each voxel in the key frame used for generating the isosurface is set with a corresponding update threshold.

In an embodiment, the distances from all voxel blocks of the current key frame to the surface of the target scenario may be calculated, and then for each matching key frame, a corresponding relationship of voxels between two frames of images may be determined according to the corresponding relationship between the current key frame and the matching key frame. According to the corresponding relationship of voxels, a voxel corresponding to the current voxel in the current key frame is found in the matching key frame to determine a corresponding update threshold, and then at least one voxel block is selected from multiple voxel blocks of the current voxel, and the distance from each of the at least one voxel block to the surface of the target scenario is less than or equal to the update threshold. In this way, each voxel in the current key frame is subjected to the above selection operation one by one to complete the filtering of voxel blocks, and the optimization and update is performed on the isosurface according to the selected voxel block. The process of obtaining the isosurface is similar to step S607 and will not be repeated here. Voxel blocks whose distances are greater than the update threshold are voxel blocks required to be ignored and are subjected to no operation. In this way, some voxel blocks are filtered and the calculation speed can be improved.

In an embodiment, to avoid searching a hash table for a hash value each time a voxel block is accessed, when the voxel block is accessed, the hash values of adjacent multiple voxel blocks may be searched for in the hash table for processing.

In step S6011, global consistent optimization and update is performed on the determined relative camera poses according to the current key frame. The relative camera poses are updated for use in updating the corresponding grid voxel model.

To ensure the real-time performance of the three-dimensional reconstruction, for each frame of image, the determination of the relative camera pose in step S602 may be performed in real time and the determination of the key frame in step S603 may be performed in real time while the capturing of the image of the target scenario in step S601 is performed. That is, the capturing of the image, the calculation of the pose, and the determination of the key frame are performed simultaneously. Moreover, the process of generating the three-dimensional reconstruction model of the target scenario in steps S605 to S607 and the process of updating the generated three-dimensional reconstruction model in steps S608 to S610 are also performed simultaneously, that is, the optimization and update of the constructed partial model is completed in the process of generating the three-dimensional reconstruction model.

This embodiment provides the depth camera based three-dimensional reconstruction method. The images of the target scenario captured by the depth camera are acquired; the relative camera poses in response to capturing the images of the target scenario by the depth camera are determined; the feature voxel of each frame of image is determined by using the manner of at least two levels of nested screening; the fusion and calculation is performed to obtain the grid voxel model of the target scenario, and the isosurface of the grid voxel model is generated to obtain the three-dimensional reconstruction model of the target scenario. Moreover, the optimization and update is performed on the three-dimensional reconstruction model of the target scenario according to the current key frame, the multiple matching key frames and non-key frames corresponding to the multiple matching key frames to ensure the global consistency of the model. A large amount of computation during three-dimensional reconstruction of the target scenario is avoided, and the application of the three-dimensional reconstruction to portable devices is achieved to make the three-dimensional reconstruction more widely applied.

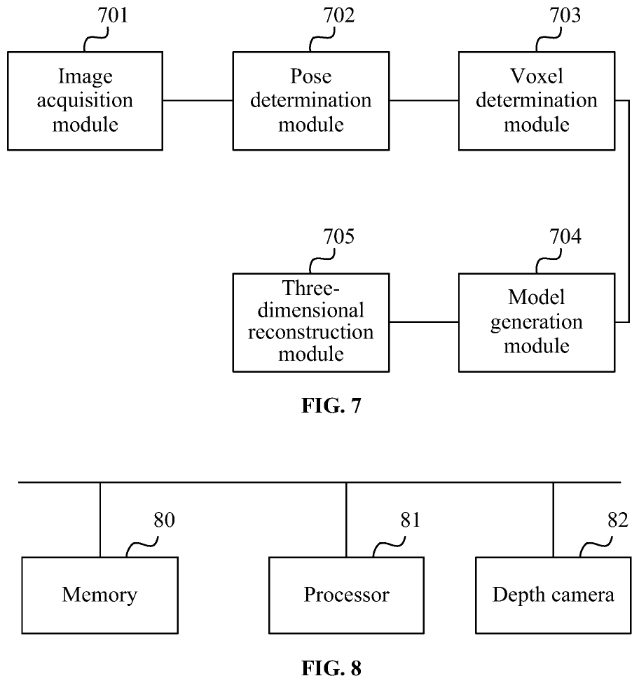

FIG. 7 is a structural block diagram of a depth camera based three-dimensional reconstruction apparatus according to an embodiment of the present application. The apparatus can execute the depth camera based three-dimensional reconstruction method provided in any embodiment of the present application, and has corresponding functional modules to execute the method. The apparatus can be implemented based on a CPU. As shown in FIG. 7, the apparatus includes an image acquisition module 701, a pose determination module 702, a voxel determination module 703, a model generation module 704, and a three-dimensional reconstruction module 705.

The image acquisition module 701 is configured to acquire at least two frames of images obtained by capturing a target scenario by a depth camera.

The pose determination module 702 is configured to determine, according to the at least two frames of images, relative camera poses in response to capturing the target scenario by the depth camera.

The voxel determination module 703 is configured to: for each frame of image, by adopting a manner of at least two levels of nested screening, determine at least one feature voxel from each frame of image, where each level of screening adopts a respective voxel partitioning rule corresponding to each level of screening.

The model generation module 704 is configured to fuse and calculate the at least one feature voxel of each frame of image according to a respective relative camera pose of each frame of image to obtain a grid voxel model of the target scenario.

The three-dimensional reconstruction module 705 is configured to generate an isosurface of the grid voxel model to obtain a three-dimensional reconstruction model of the target scenario.

In an embodiment, the three-dimensional reconstruction module 705 is configured to: in response to that a current frame of image obtained by capturing the target scenario is determined as a key frame, generate an isosurface of a voxel block corresponding to a current key frame, and add a color to the isosurface to obtain the three-dimensional reconstruction model of the target scenario.

This embodiment provides the depth camera based three-dimensional reconstruction apparatus. The images of the target scenario captured by the depth camera are acquired, the camera poses in response to capturing the images of the target scenario by the depth camera are determined, the feature voxel of each frame of image is determined by adopting the manner of at least two levels of nested screening, the fusion and calculation is performed to obtain the grid voxel model of the target scenario, the isosurface of the grid voxel model is generated, and the three-dimensional reconstruction model of the target scenario is obtained. A large amount of computation during three-dimensional reconstruction of the target scenario is avoided, and the application of the three-dimensional reconstruction to portable devices is achieved to make the three-dimensional reconstruction more widely applied.

In an embodiment, the pose determination module 702 includes a feature point extraction unit, a matching operation unit, and a pose determination unit.

The feature point extraction unit is configured to perform feature extraction on each frame of image to obtain at least one feature point of each frame of image.

The matching operation unit is configured to perform a matching operation on feature points of two adjacent frames of images to obtain corresponding relationships of the feature points between the two adjacent frames of images.

The pose determination unit is configured to remove an abnormal corresponding relationship from the corresponding relationships of the feature points, calculate a non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$

in J(ξ)^{T}J(ξ)through a linear component including second order statistics of remaining feature points and a non-linear component including the relative camera poses, perform multiple iteration calculations on δ=−(J(ξ)^{T}J(ξ))⁻¹J(ξ)^{T}r(ξ), and solve a relative camera pose in the case where a re-projection error is less than a preset error threshold.

Here, r(ξ) denotes a vector including all re-projection errors, J(ξ) is a Jacobian matrix of r(ξ), ξ denotes a Lie algebra of a relative camera pose, and δ denotes a delta value of r(ξ) at each iteration; Rᵢ denotes a rotation matrix of a camera when an i-th frame of image is captured; Rⱼ denotes a rotation matrix of the camera when a j-th frame of image is captured; pᵢ^{k} denotes a k-th feature point on the i-th frame of image; pⱼ^{k} denotes a k-th feature point on the j-th frame of image; C_{i,j} denotes a set of corresponding relationships of feature points between the i-th frame of image and the j-th frame of image; ∥C_{i,j}∥−1 denotes the number of corresponding relationships of the feature points between the i-th frame of image and the j-th frame of image; [ ]ₓ denotes a vector product; and ∥C_{i,j}∥ denotes norm of C_{i,j}. In an embodiment, the expression of the non-linear term

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$

is:

$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times } = [ \begin{matrix}- {r}_{i 2}^{T} W {r}_{j 2} - {r}_{i 1}^{T} {Wr}_{j 1} & {r}_{i 1}^{T} {Wr}_{j 0} & {r}_{i 2}^{T} {Wr}_{j 0} \\ {r}_{i 0}^{T} {Wr}_{j 1} & - {r}_{i 2}^{T} {Wr}_{j 2} - {r}_{i 0}^{T} {Wr}_{j 0} & {r}_{i 2}^{T} {Wr}_{j 1} \\ {r}_{i 0}^{T} {Wr}_{j 2} & {r}_{i 1}^{T} {Wr}_{j 2} & - {r}_{ i 0}^{T} {Wr}_{j 0} - {r}_{i 1}^{T} {Wr}_{j 1}\end{matrix} ] .$$

Here,

$$W = {\sum }_{k = 0}^{‖ {C}_{i , j} ‖ - 1} {p}_{i}^{k} {p}_{j}^{{k}^{T}}$$

denotes a linear component, rᵢₗ^{T} and rⱼₗ denote non-linear components, rᵢₗ^{T} is an l-th row in a rotation matrix Rᵢ, rⱼₗ is transpose of an l-th row in a rotation matrix Rⱼ, and l=0,1,2.

In an embodiment, the apparatus further includes a key frame determination module, a loop closure detection module, and a pose update module.

The key frame determination module is configured to: perform a matching operation on the current frame of image obtained by capturing the target scenario and a previous key frame of image to obtain a conversion relationship matrix between the current frame of image and the previous key frame of image; and in response to that the conversion relationship matrix is greater than or equal to a preset conversion threshold, determine the current frame of image as the current key frame.

The loop closure detection module is configured to: in response to that a current frame of image obtained by capturing the target scenario is determined as a key frame, perform a loop closure detection according to the current key frame and a historical key frame.

The pose update module is configured to: in response to that the loop closure is successful, perform global consistent optimization and update on the determined relative camera poses according to the current key frame.

In an embodiment, the voxel determination module 703 includes an initial determination unit, an index block determination unit, a feature block selection unit, a feature voxel determination unit, and a loop unit.

The initial determination unit is configured to: for each frame of image, use the image as a current-level screening object, and determine a current-level voxel unit.

The index block determination unit is configured to divide the current-level screening object into voxel blocks according to the current-level voxel unit, and determine at least one current index block according to the voxel blocks; where the current index block includes a preset number of voxel blocks.

The feature block selection unit is configured to select at least one feature block from all the current index blocks, where a distance from each of the at least one feature block to a surface of the target scenario is less than a distance threshold corresponding to the current-level voxel unit.

The feature voxel determination unit is configured to: if a feature block satisfies a division condition of a minimum-level voxel unit, use the feature block as a feature voxel.

The loop unit is configured to: if the feature block does not satisfy the division condition of the minimum-level voxel unit, use all the feature blocks determined from the current-level screening object as a new current-level screening object, select a next-level voxel unit as a new current-level voxel unit, and return to the operation of dividing the current-level screening object into voxel blocks; where a voxel unit gradually becomes smaller to the minimum-level voxel unit.

In an embodiment, the feature block selection unit is configured to: for each current index block, access an index block according to a hash value of the current index block, and respectively calculate distances from all vertices of the current index block to the surface of the target scenario according to an image depth value obtained by the depth camera and the respective relative camera pose in response to capturing each frame of image; and select a current index block, in which the distances from all the vertices of the current index block to the surface of the target scenario are each less than the distance threshold corresponding to the current-level voxel unit, as a feature block.

In an embodiment, the apparatus further includes a matching frame determination module, a model update module, and an isosurface update module.

The matching frame determination module is configured to: in response to that a current frame of image obtained by capturing the target scenario is determined as a key frame, select a first preset number of matching key frames matched with the current key frame from historical key frames, and acquire a second preset number of non-key frames from non-key frames corresponding to the selected matching key frames.

The model update module is configured to perform optimization and update on the grid voxel model of the three-dimensional reconstruction model according to the acquired non-key frames and a corresponding relationship between the current key frame and each matching key frame.

The isosurface update module is configured to perform optimization and update on the isosurface of the three-dimensional reconstruction model according to the corresponding relationship between the current key frame and each matching key frame.

In an embodiment, the isosurface update module is configured to: for each matching key frame, select at least one voxel block from multiple voxel blocks corresponding to the current key frame, where a distance from each of the at least one voxel block to a surface of the target scenario is less than or equal to an update threshold of a corresponding voxel in a matching key frame; and perform optimization and update on an isosurface of the matching key frame according to the selected at least one voxel block.

The three-dimensional reconstruction module 705 is further configured to: for each voxel in a key frame used for generating the isosurface, select the maximum value from distances each of which is from one of all voxel blocks in the voxel to the surface of the target scenario and set the maximum value as an update threshold of the voxel while generating the isosurface of the voxel block corresponding to the current key frame of image.

FIG. 8 is a structural diagram of an electronic device according to an embodiment of the present application. As shown in FIG. 8, the electronic device includes a memory 80, one or more processors 81, and at least one depth camera 82. The memory 80, the processor 81 and the depth camera 82 of the electronic device may be connected via a bus or in other manners, and connecting via a bus is used as an example in FIG. 8.

As a computer-readable storage medium, the memory 80 may be configured to store software programs, computer-executable programs and modules, such as modules (e.g., the image acquisition module 701 disposed in the depth camera based three-dimensional reconstruction apparatus) corresponding to the depth camera based three-dimensional reconstruction apparatus in the embodiments of the present application. The processor 81 processes the software programs, instructions and modules stored in the memory 80 to perform various functional applications and data processing of the electronic device, that is, to implement the depth camera based three-dimensional reconstruction method described above. In an embodiment, the processor 81 may be a central processing unit or a high-performance graphics processing unit.

The memory 80 may mainly include a program storage area and a data storage area. The program storage area may store an operating system and an application program required for implementing at least one function and the data storage area may store data created depending on use of terminals. In addition, the memory 80 may include a high-speed random access memory, and may also include a nonvolatile memory, such as at least one disk memory, flash memory or another nonvolatile solid-state memory. In some examples, the memory 80 may include memories which are remotely disposed relative to the processor 81 and these remote memories may be connected to the device via a network. Examples of the preceding network include, but are not limited to, the Internet, an intranet, a local area network, a mobile communication network and a combination thereof.

The depth camera 82 may be configured to capture an image of a target scenario under the control of the processor 81. The depth camera may be embedded in the electronic device. In an embodiment, the electronic device may be a portable mobile electronic device, for example, the electronic device may be a smart terminal (mobile phone or tablet computer) or a three-dimensional visual interaction device (Virtual Reality (VR) glasses or wearable helmet), and may capture images under operations such as movement, rotation, etc.

The electronic device provided in this embodiment may be configured to execute the depth camera based three-dimensional reconstruction method provided in any embodiment described above, and has the corresponding functions.

An embodiment of the present application further provides a computer-readable storage medium storing a computer program, where the program, when executed by a processor, may implement the depth camera based three-dimensional reconstruction method described in the above embodiments.

The computer storage medium in this embodiment of the present application may employ any combination of one or more computer-readable media. The computer-readable medium may be a computer-readable signal medium or a computer-readable storage medium. The computer-readable storage medium may be, but is not limited to, an electrical, magnetic, optical, electromagnetic, infrared or semiconductor system, apparatus or device, or any combination thereof. More specific examples of the computer-readable storage medium include (non-exhaustive list): an electrical connection having one or more wires, a portable computer magnetic disk, a hard disk, a random access memory (RAM), a read only memory (ROM), an erasable programmable read only memory (EPROM) or flash memory, an optical fiber, a portable compact disc read-only memory (CD-ROM), an optical memory device, a magnetic memory device, or any suitable combination thereof In this document, the computer-readable storage medium may be any tangible medium including or storing a program. The program may be used by or used in conjunction with an instruction execution system, apparatus or device.

The computer-readable signal medium may include a data signal propagated in a baseband or as part of a carrier, where the data signal carries computer-readable program codes. Such propagated data signal may be in multiple forms including, but not limited to, an electromagnetic signal, an optical signal or any suitable combination thereof. The computer-readable signal medium may further be any computer-readable medium other than a computer-readable storage medium. The computer-readable medium may send, propagate or transmit the program used by or used in conjunction with the instruction execution system, apparatus or device.

The program codes included on the computer-readable medium may be transmitted by using any suitable medium, including, but not limited to, a wireless medium, a wired medium, an optical cable, radio frequency (RF), and the like, or any suitable combination thereof.

Computer program codes for performing the operations of the present application may be written in one or more programming languages or a combination thereof, the programming languages including object-oriented programming languages such as Java, Smalltalk, C++ and further including conventional procedural programming languages such as “C” programming language or similar programming languages. The program codes may be executed entirely on a user computer, partly on the user computer, as a stand-alone software package, partly on the user computer and partly on a remote computer, or entirely on the remote computer or electronic device. In the case relating to the remote computer, the remote computer may be connected to a user computer via any type of network including a local area network (LAN) or a wide area network (WAN), or may be connected to an external computer (for example, via the Internet through an Internet service provider).

In summary, according to the depth camera based three-dimensional reconstruction solution provided by the embodiments of the present application, a coarse-to-fine nested screening strategy and an idea of sparse sampling are adopted for selecting feature voxels in the stage of fusion and calculation, ensuring the reconstruction accuracy and meanwhile greatly improving the fusion speed; and the isosurface generation according to the key frame rate can increase the generation speed of the isosurface, improving the efficiency of three-dimensional reconstruction. In addition, the global consistency of three-dimensional reconstruction can be effectively ensured through the stage of optimization and update.

The serial numbers of the above embodiments are merely for ease of description and do not indicate superiority and inferiority of the embodiments.

Those of ordinary skill in the art should know that the above modules or operations of the embodiments of the present application may be implemented by a general-purpose computing apparatus, the modules or operations may be concentrated on a single computing apparatus or distributed on a network composed of multiple computing apparatuses. For example, the modules or operations may be implemented by program codes executable by the computing apparatus, so that the modules or operations may be stored in a storage apparatus and executed by the computing apparatus. Alternatively, the modules or operations may be made into integrated circuit modules separately, or multiple modules or operations therein may be made into a single integrated circuit module for implementation. In this way, the present application is not limited to any specific combination of hardware and software.

The embodiments in this Description are described in a progressive manner. Each embodiment focuses on differences from other embodiments. The same or similar parts in the embodiments can be referred to by each other.

1. A depth camera based three-dimensional reconstruction method, comprising:
acquiring at least two frames of images obtained by capturing a target scenario by a depth camera;
determining, according to the at least two frames of images, relative camera poses in response to capturing the target scenario by the depth camera;
by adopting a manner of at least two levels of nested screening, determining at least one feature voxel from each of the at least two frames of images, wherein each level of screening adopts a respective voxel partitioning rule corresponding to each level of screening;
fusing and calculating the at least one feature voxel of each of the at least two frames of images according to a respective relative camera pose of each of the at least two frames of images to obtain a grid voxel model of the target scenario; and
generating an isosurface of the grid voxel model to obtain a three-dimensional reconstruction model of the target scenario.

2. The method of claim 1, wherein determining, according to the at least two frames of images, the relative camera poses in response to capturing the target scenario by the depth camera comprises:
performing a feature extraction on each of the at least two frames of images to obtain at least one feature point of each of the at least two frames of images;
performing a matching operation on feature points of two adjacent frames of images to obtain corresponding relationships of the feature points between the two adjacent frames of images; and
removing an abnormal corresponding relationship from the corresponding relationships of the feature points, calculating a non-linear term
$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$
in J(ξ)^{T}J(ξ) through a linear component comprising second order statistics of remaining feature points and a non-linear component comprising relative camera poses, performing a plurality of iteration calculations on δ=−(J(ξ)^{T}J(ξ))⁻¹J(ξ)^{T}r(ξ), and solving a relative camera pose in a case where a re-projection error is less than a preset error threshold;
wherein r(ξ)denotes a vector comprising all re-projection errors, J(ξ) is a Jacobian matrix of r(ξ), ξ denotes a Lie algebra of a relative camera pose, and δ denotes a delta value of r(ξ)at each iteration; Rᵢ denotes a rotation matrix of a camera when an i-th frame of image is captured; Rᵢ denotes a rotation matrix of the camera when a j-th frame of image is captured; pᵢ^{k} denotes a k-th feature point on the i-th frame of image; pⱼ^{k} denotes a k-th feature point on the j-th frame of image; c_{i,j} denotes a set of corresponding relationships of feature points between the i-th frame of image and the j-th frame of image; ∥C_{i,j}∥−1 denotes a number of the corresponding relationships of the feature points between the i-th frame of image and the j-th frame of image; [ ]ₓ denotes a vector product; and ∥C_{i,j}∥ denotes a norm of C_{i,j}.

3. The method of claim 2, wherein an expression of the non-linear term
$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times }$$
is:
$${\sum }_{k = 0}^{‖ {C}_{i , j} ‖ - 1} {{[ {R}_{i} {p}_{i}^{k} ]}_{\times } [ {R}_{j} {p}_{j}^{k} ]}_{\times } = [ \begin{matrix}- {r}_{i 2}^{T} W {r}_{j 2} - {r}_{i 1}^{T} {Wr}_{j 1} & {r}_{i 1}^{T} {Wr}_{j 0} & {r}_{i 2}^{T} {Wr}_{j 0} \\ {r}_{i 0}^{T} {Wr}_{j 1} & - {r}_{i 2}^{T} {Wr}_{j 2} - {r}_{i 0}^{T} {Wr}_{j 0} & {r}_{i 2}^{T} {Wr}_{j 1} \\ {r}_{i 0}^{T} {Wr}_{j 2} & {r}_{i 1}^{T} {Wr}_{j 2} & - {r}_{ i 0}^{T} {Wr}_{j 0} - {r}_{i 1}^{T} {Wr}_{j 1}\end{matrix} ] ;$$
wherein
$$W = {\sum }_{k = 0}^{‖ {C}_{i , j} ‖ - 1} {p}_{i}^{k} {p}_{j}^{{k}^{T}}$$
denotes a linear component, rᵢₗ^{T} and rⱼₗ denote non-linear components, rᵢₗ^{T} is an l-th row in a rotation matrix Rᵢ, rⱼₗ is transpose of an l-th row in a rotation matrix Rⱼ, and l=0,1,2.

4. The method of claim 1, after determining, according to the at least two frames of images, the relative camera poses in response to capturing the target scenario by the depth camera, the method further comprising:
in response to a current frame of image obtained by capturing the target scenario being determined as a current key frame, performing a loop closure detection according to the current key frame and a historical key frame;
in response to the loop closure being successful, performing global consistent optimization and update on the determined relative camera poses according to the current key frame.

5. The method of claim 4, before performing the loop closure detection according to the current key frame and the historical key frame, the method further comprising:
performing a matching operation on the current frame of image obtained by capturing the target scenario and a previous key frame of image to obtain a conversion relationship matrix between the current frame of image and the previous key frame of image; and
in response to the conversion relationship matrix being greater than or equal to a preset conversion threshold, determining the current frame of image as the current key frame.

6. The method of claim 1, wherein for the each of the at least two frames of images, by adopting the manner of at least two levels of nested screening, determining the at least one feature voxel from the each of the at least two frames of images comprises:
for each of the at least two frames of images, using each of the at least two frames of images as a current-level screening object, and determining a current-level voxel unit;
dividing the current-level screening object into voxel blocks according to the current-level voxel unit, and determining at least one current index block according to the voxel blocks; wherein the at least one current index block comprises a preset number of voxel blocks;
selecting at least one feature block from all current index blocks, wherein a distance from each of the at least one feature block to a surface of the target scenario is less than a distance threshold corresponding to the current-level voxel unit;
in a case where the at least one feature block satisfies a division condition of a minimum-level voxel unit, using the at least one feature block as the at least one feature voxel;
in a case where the at least one feature block does not satisfy the division condition of the minimum-level voxel unit, using all feature blocks determined from the current-level screening object as a new current-level screening object, selecting a next-level voxel unit as a new current-level voxel unit, and returning to the operation of dividing the current-level screening object into voxel blocks;
wherein a voxel unit gradually becomes smaller to the minimum-level voxel unit.

7. The method of claim 6, wherein selecting the at least one feature block from all current index blocks, wherein the distance from each of the at least one feature block to the surface of the target scenario is less than the distance threshold corresponding to the current-level voxel unit, comprises:
for each of the at least one current index block having a plurality of vertices, accessing the current index block according to a hash value of the current index block, and calculating respectively a distance from each of the plurality of vertices of the current index block to the surface of the target scenario according to an image depth value obtained by the depth camera and the respective relative camera pose in response to capturing each of the at least two frames of images; and
selecting at least one current index block, in which the distance from each of the plurality of vertices of the current index block to the surface of the target scenario is less than the distance threshold corresponding to the current-level voxel unit, as the at least one feature block.

8. The method of claim 1, wherein generating the isosurface of the grid voxel model to obtain the three-dimensional reconstruction model of the target scenario comprises:
in response to a current frame of image obtained by capturing the target scenario being determined as a current key frame, generating an isosurface of a voxel block corresponding to the current key frame, and adding a color to the isosurface to obtain the three-dimensional reconstruction model of the target scenario.

9. The method of claim 1, after generating the isosurface of the grid voxel model to obtain the three-dimensional reconstruction model of the target scenario, the method further comprising:
in response to a current frame of image obtained by capturing the target scenario being determined as a current key frame, selecting a first preset number of matching key frames matched with the current key frame from historical key frames, and acquiring a second preset number of non-key frames from non-key frames corresponding to the selected matching key frames;
performing optimization and update on the grid voxel model of the three-dimensional reconstruction model according to the acquired second preset number of non-key frames and a corresponding relationship between the current key frame and each of the first preset number of matching key frames; and
performing optimization and update on the isosurface of the three-dimensional reconstruction model according to the corresponding relationship between the current key frame and each of the first preset number of matching key frames.

10. The method of claim 9, wherein performing the optimization and the update on the isosurface of the three-dimensional reconstruction model according to the corresponding relationship between the current key frame and each of the first preset number of matching key frames comprises:
for each of the first preset number of matching key frames, selecting at least one voxel block from a plurality of voxel blocks corresponding to the current key frame, wherein a distance from each of the at least one voxel block to a surface of the target scenario is less than or equal to an update threshold of a corresponding voxel in the each of first preset number of matching key frames; and
performing optimization and update on an isosurface of the each of the first preset number of matching key frames according to the selected at least one voxel block.

11. The method of claim 10, wherein generating the isosurface of the grid voxel model comprises:
for each voxel in the key frame used for generating the isosurface, selecting a maximum value from distances each of which is from one of all voxel blocks in the each voxel to the surface of the target scenario, and setting the maximum value as the update threshold of the voxel.

12. A depth camera based three-dimensional reconstruction apparatus, comprising:
an image acquisition module, which is configured to acquire at least two frames of images obtained by capturing a target scenario by a depth camera;
a pose determination module, which is configured to determine, according to the at least two frames of images, relative camera poses in response to capturing the target scenario by the depth camera;
a voxel determination module, which is configured to: for each of the at least two frames of images, by adopting a manner of at least two levels of nested screening, determine at least one feature voxel from each of the at least two frames of images, wherein each level of screening adopts a respective voxel partitioning rule corresponding to each level of screening;
a model generation module, which is configured to fuse and calculate the at least one feature voxel of each of the at least two frames of images according to a respective relative camera pose of each of the at least two frames of images to obtain a grid voxel model of the target scenario; and
a three-dimensional reconstruction module, which is configured to generate an isosurface of the grid voxel model to obtain a three-dimensional reconstruction model of the target scenario.

13. An electronic device, comprising:
at least one processor;
a memory, which is configured to store at least one program; and
at least one depth camera, which is configured to perform image capture on a target scenario;
wherein the at least one program, when executed by the at least one processor, causes the at least one processor to implement the depth camera based three-dimensional reconstruction method of claim 1.

14. The device of claim 13, wherein the at least one processor is a central processing unit, and the electronic device is a portable mobile electronic device.

15. A computer-readable storage medium, storing a computer program, wherein the program, when executed by a processor, implements the depth camera based three-dimensional reconstruction method of claim 1.

16. The method of claim 2, after determining, according to the at least two frames of images, the relative camera poses in response to capturing the target scenario by the depth camera, the method further comprising:
in response to a current frame of image obtained by capturing the target scenario being determined as a current key frame, performing a loop closure detection according to the current key frame and a historical key frame;
in response to the loop closure being successful, performing global consistent optimization and update on the determined relative camera poses according to the current key frame.

17. The method of claim 16, before performing the loop closure detection according to the current key frame and the historical key frame, the method further comprising:
performing a matching operation on the current frame of image obtained by capturing the target scenario and a previous key frame of image to obtain a conversion relationship matrix between the current frame of image and the previous key frame of image; and
in response to the conversion relationship matrix being greater than or equal to a preset conversion threshold, determining the current frame of image as the current key frame.
